(19) United States
(12) Patent Application Publication
(10) Pub. No.: US 2014/0176564 A1
(43) Pub. Date: Jun. 26, 2014

(54) Chinese Character Constructing Method and Device, Character Constructing Method and Device, and Font Library Building Method

(71) Applicants: Peking University, Haidian District (BE); Beijing Founder Electronics Co., Ltd., Haidian District (BE); Peking University Founder Group Co., Ltd., Haidian District (BE)

(72) Inventors: Yingmin Tang, Beijing (CN); Lei Ma, Beijing (CN); Yang Liu, Beijing (CN); Chenxi Wang, Beijing (CN); Jinni Liu, Beijing (CN); Ying Luan, Beijing (CN); Pingping Yu, Beijing (CN)

(21) Appl. No.: 14/130,603

(22) PCT Filed: Dec. 31, 2012
(86) PCT No.: PCT/CN2012/088100

§ 371 Date: Jan. 2, 2014

(30) Foreign Application Priority Data
Dec. 31, 2011 (CN) 201110459270.5

(51) Int. Cl. G06T 11/60; G06F 17/21

(52) U.S. Cl. CPC G06T 11/60; G06F 17/214
USPC 345/471

(57) ABSTRACT

Disclosed is a character constructing method and device, and a font library building method. The method includes obtaining a character code, a component code, and a structure code of a character to be constructed, and extracting a character component from a character component library according to the component code, the structure code specifying the structure of the character and a position of a character component in the character; generating glyph data of the character by using the character component according to the structure code, and matching the glyph data with the character code. The font library building method includes generating glyph data and a character code corresponding to a character by using the character constructing method, and building a font library by using the glyph data. The characters are preferably Chinese characters.

### TECHNICAL FIELD

The present invention relates to the technical field of font library, and specifically relates to a Chinese character constructing method and device, a character constructing method and device, and a font library building method.

### BACKGROUND ART

In electronic devices, Chinese characters are represented in the form of character codes (such as Unicode, GB2312 etc.); however, the character codes are only codes within the electronic devices, glyph data must be used if a Chinese character needs to be displayed or printed in a certain font (such as boldface, Song typeface), the glyph data may be in forms of a skeleton map, a bitmap, a vectogram, for specifying what the Chinese character “looks like”; and the process of constructing glyph data of a Chinese character and making it correspond to the character code is called “character constructing”. Apparently, the glyph data of the same Chinese character in different font libraries are not the same, hence, a huge amount of character constructing work should be done to build a new font library.

The existing Chinese character constructing method is generally such that font designers firstly design hundreds of commonly used Chinese characters using one font, then the staff construct the glyph data of other Chinese characters stroke by stroke according to their feelings on the basis of these commonly used Chinese characters and make adjustments to them.

The inventors find that there are at least the following problems in the prior art: the existing Chinese character constructing method is performed character by character manually, which is of low efficiency, takes long time (e.g. it generally takes several months to construct a conventional font library of about ten thousand characters), and has high cost. Especially when constructing characters for a super font library (e.g., a font library for use in Chinese character study field) containing hundreds of thousands of Chinese characters is performed, the work amount would be more enormous. Meanwhile, no matter how large the font library is, it is impossible for it to contain all Chinese characters that might be used by people, so, when an user uses some characters (such as rare characters or self-constructed characters) that are not contained in the font library, these characters cannot be displayed or cannot be displayed in the required font.

### SUMMARY OF THE INVENTION

The technical problems to be solved by the present invention includes the problem in the prior art that the Chinese character constructing method has low efficiency, high cost and cannot structure characters in real time, therefore, there provides a Chinese character constructing method that has high efficiency, low cost and can structure characters in real time.

The technical solution adopted for solving the technical problem of the present invention is a Chinese character constructing method, comprising:

obtaining a character code, a component code, and a structure code of a Chinese character to be constructed, and extracting a corresponding Chinese character component from a Chinese character component library according to the component code, wherein the structure code specifies a structure of the Chinese character and a position of the Chinese character component in the Chinese character;

generating glyph data of the Chinese character by using the Chinese character component according to the structure code, and making the glyph data of the Chinese character correspond to the character code of the Chinese character.

A “Chinese character component” refers to a relatively independent structure unit in a Chinese character, and it can be classified in different ways. For example, the Chinese character components can be either “strokes”, such as horizontal strokes (“ [symbol] ”), dots (“ [symbol] ”) etc., or “radicals”, such as Single side (“ [symbol] ”), Lidao side (“ [symbol] ”) Baogai head (“ [symbol] ”) etc., or constituent parts of Chinese characters, such as “ [symbol] ” at the bottom of the Chinese character “ [symbol] ” and the remainder “ [symbol] ” after removing “ [symbol] ”, each of which can be taken as a Chinese character component. It shall be noted that a Chinese character component also depends on its size and shape, so units with the same strokes and same structure might be different Chinese character components, for example, both strokes at the topsides of “ [symbol] ” and “ [symbol] ” are a “horizontal stroke”, however, the two horizontal strokes are different in width and shape, so they can be regarded as two Chinese character components; as another example, both the characters “ [symbol] ” and “ [symbol] ” contain a “ [symbol] ”, however, the two are different in size and shape, so they can be regarded as two Chinese character components. Indeed, since there are extremely large amount of Chinese characters, it is impossible to take each structure unit of each Chinese character as an individual Chinese character component, as for several structure units with relatively high similarities, only one of them can be chosen as a Chinese character component; for example, if it is deemed that the three “ [symbol] ” components in the Chinese character “ [symbol] ” are different in shape but the differences are slight, only one of them can be chosen as the Chinese character component. In a word, there is no absolute standard for division for Chinese character components, however, from the perspective of convenience, a structure unit that is relatively common, relatively independent and has a relatively similar shape in the Chinese characters can be generally taken as a Chinese character component.

Preferably, before obtaining a character code, a component code, and a structure code of a Chinese character to be constructed, it further comprises: obtaining a Chinese character component, and granting a component code to the Chinese character component to build a Chinese character component library, so that the Chinese character component and the corresponding component code are stored in the Chinese character component library.

Further preferably, the step of obtaining a Chinese character component is specifically obtaining a Chinese character component through a Chinese character component obtaining unit, the Chinese character component obtaining unit being at least one of a handwriting recording device, an image obtaining device, an image processing device, and a data storage device.

Further preferably, the step of constructing a Chinese character component library further comprises: obtaining component parameters of the Chinese character component in the Chinese character component library, and storing the component parameters in the Chinese character component library, the component parameters comprise at least one of height of the component, width of the component, aspect ratio of the component, area of the component, black-white ratio of the component, center of gravity of the component, source character of the component, original position of the component, and recommended position of the component; selecting Chinese character components of the same shape according to the component parameters.

Preferably, in the Chinese character component library, one component code corresponds to a plurality of Chinese character components of the same shape, and the step of extracting a corresponding Chinese character component from a Chinese character component library according to the component code specifically comprises: obtaining a plurality of Chinese character components of the same shape that correspond to the component code according to the component code, then extracting a desired Chinese character component from the plurality of Chinese character components of the same shape according to the component parameters.

Preferably, the structure code is a structure code of IDS attributes in ISO 10646 Standard.

Preferably, the step of obtaining a character code, a component code, and a structure code of a Chinese character to be constructed comprises: obtaining a character code, a component code, and a structure code of a Chinese character to be constructed through an input device; or obtaining a character code, a component code, and a structure code of a Chinese character to be constructed from a pre-stored code correspondence table, in which the correspondence of the character code, the component code, and the structure code of a Chinese character to be constructed is stored.

Preferably, the step of generating glyph data of the Chinese character by using the Chinese character component according to the structure code comprises:

Step 1, placing the Chinese character components at a designated position according to the structure code so as to obtain an intermediate glyph;

Step 2, determining whether the glyph parameters of the intermediate glyph meet predetermined values respectively, and if yes, proceeding to step 5, otherwise, proceeding to step 3;

Step 3, adjusting the intermediate glyph based on the differences between the glyph parameters and the predetermined values;

Step 4, determining whether the glyph parameters of the adjusted intermediate glyph meet the predetermined values, and whether the number of times of adjustment exceeds a limit, and if at least one yes, proceeding to step 5, otherwise, returning to step 3;

Step 5, generating glyph data of the Chinese character according to the current intermediate glyph.

Further preferably, the glyph parameters comprise at least one of height of the Chinese character, width of the Chinese character, aspect ratio of the Chinese character, area of the Chinese character, black-white ratio of the Chinese character, center of gravity of the Chinese character, height of the component, width of the component, aspect ratio of the component, area of the component, black-white ratio of the component, center of gravity of the component, distance between components, and size ratio between components.

Further preferably, the process of adjusting the intermediate glyph in step 3 comprises at least one of the following adjusting operations: adjusting the height of the Chinese character, adjusting the width of the Chinese character, adjusting the area of the Chinese character, adjusting the black-white ratio of the Chinese character, adjusting the height of the component, adjusting the width of the component, adjusting the area of the component, adjusting the black-white ratio of the component, adjusting the position of the component.

Preferably, the glyph parameters of the middle glyph are obtained by analyzing and calculating the intermediate glyph, or by calculating the component parameters of the Chinese character component in the Chinese character component library.

In the Chinese character constructing method of the present invention, a Chinese character component library can be used to accomplish the character constructing process automatically, thereby increasing the constructing efficiency greatly, reducing the constructing time and reducing the constructing cost; meanwhile, when an user wants to use a rare character or a self-constructed character that is not contained in the font library, he or she may construct the character by himself or herself and add the required Chinese character into the font library, which makes it easy to use.

The technical problems to be solved by the present invention further includes the problem in the prior art that the font library building method has low efficiency, high cost and cannot structure characters in real time, therefore, there provides a font library building method that is of high efficiency, low cost and capable of constructing characters in real time.

The technical solution adopted for solving the technical problem of the present invention is a font library building method, comprising:

generating glyph data and a character code corresponding to a Chinese character by using the above-described Chinese character constructing method;

building a font library by using the obtained glyph data of the Chinese character.

In the font library building method of the present invention, a Chinese character component library can be used to accomplish the character constructing process automatically so as to build a font library accordingly, thereby increasing the efficiency of building a font library greatly, reducing the time for building a font library, and reducing cost of building a font library, and this is especially true for a super font library; meanwhile, when the user wants to use a rare character or a self-constructed character that is not contained in the font library, he or she may construct the character by himself or herself and add the required Chinese character into the font library, which makes it easy to use.

The technical problems to be solved by the present invention, further includes the problem in the prior art that the Chinese character constructing technology has low efficiency, high cost and cannot structure characters in real time, therefore, there provides a font library building device that is of high efficiency, low cost and capable of constructing characters in real time.

The technical solution adopted for solving the technical problem of the present invention is a Chinese character constructing device, comprising:

a code obtaining unit for obtaining a character code, a component code, and a structure code of a Chinese character to be constructed, wherein the structure code specifies a structure of the Chinese character and a position of the Chinese character component in the Chinese character;

a Chinese character component extracting unit for extracting a corresponding Chinese character component from a Chinese character component library according to the component code;

a glyph data generating unit for generating glyph data of the Chinese character by using the Chinese character component according to the structure code, and making the glyph data of the Chinese character correspond to the character code of the Chinese character.

Preferably, the Chinese character constructing device further comprises:

a Chinese character component library storing unit for storing the Chinese character component library in which the Chinese character component and the corresponding component code are stored.

Preferably, Chinese character constructing device further comprises:

a Chinese character component obtaining unit for obtaining a Chinese character component and providing it to the Chinese character component library storing unit.

Preferably, the Chinese character component obtaining unit is at least one of a handwriting recording device, an image obtaining device, an image processing device, and a data storage device.

Preferably, the Chinese character component library also stores component parameters of the Chinese character components, and the component parameters comprise at least one of height of the component, width of the component, aspect ratio of the component, area of the component, black-white ratio of the component, center of gravity of the component, source character of the component, original position of the component, and recommended position of the component; and

the Chinese character component extracting unit is further used for extracting the component parameters in the Chinese character component library, and selecting a desired Chinese character component from the extracted plurality of Chinese character components of the same shape that correspond to the same component code according to the component parameters.

The character constructing process can be automatically accomplished by using the Chinese character constructing device of the present invention, thereby increasing the constructing efficiency greatly, reducing the constructing time and reducing the constructing cost; meanwhile, when the user wants to use a rare character or a self-constructed character that is not contained in the font library, he or she may construct the character by himself or herself and add the required Chinese character into the font library, which makes it easy to use.

The above-described Chinese character constructing method and device are also adapted for constructing other characters comprising at least one component and having a certain structure, other than Chinese characters, hence, the present invention further provides a character constructing method, comprising:

obtaining a character code, a component code, and a structure code of a character to be constructed, and extracting a corresponding character component from a component library according to the component code, wherein the structure code specifies a structure of the character and a position of the character component in the character;

generating glyph data of the character by using the character component according to the structure code, and making the glyph data of the character correspond to the character code of the character.

The present invention further provides a font library building method, comprising:

generating glyph data and a character code of a corresponding character by using the above-described character constructing method; and building a font library by using the obtained glyph data of the character.

The present invention further provides a character constructing device, comprising:

a code obtaining unit for obtaining a character code, a component code, and a structure code of a character to be constructed, wherein the structure code specifies a structure of the character and a position of the character component in the character; and

a component extracting unit for extracting a corresponding character component from a component library according to the component code; and

a glyph data generating unit for generating glyph data of the character by using the character component according to the structure code, and making the glyph data of the character correspond to the character code of the character.

The present invention is particularly applicable to building a super font library.

### BRIEF DESCRIPTION OF THE DRAWINGS

FIG. 1 is a schematic diagram of a character constructing process of a Chinese character constructing method according to an embodiment of the present invention;

FIG. 2 is a schematic diagram of another character constructing process of a Chinese character constructing method according to an embodiment of the present invention;

FIG. 3 is a flow chart of the Chinese character constructing method according to the second embodiment of the present invention;

FIG. 4 is a flow chart of the detailed process of generating glyph data in the Chinese character constructing method according to the second embodiment of the present invention.

### DETAILED DESCRIPTION OF PREFERRED EMBODIMENTS

To enable those skilled in the art to understand the technical solution of the present invention better, the present invention will be further described in detail below with reference to the figures and specific embodiments.

### The First Embodiment

The present embodiment provides a Chinese character constructing method, comprising:

obtaining a character code, a component code, and a structure code of a Chinese character to be constructed, and extracting a corresponding Chinese character component from a Chinese character component library according to the component code, wherein the structure code specifies a structure of the Chinese character and a position of the Chinese character component in the Chinese character;

generating glyph data of the Chinese character by using the Chinese character component according to the structure code, and associating the glyph data of the Chinese character with the character code of the Chinese character.

In the Chinese character constructing method of the present embodiment, a Chinese character component library can be used to accomplish the character constructing process automatically, thereby increasing the constructing efficiency greatly, reducing the constructing time and reducing the constructing cost; meanwhile, when an user wants to use a rare character or a self-constructed character that is not contained in the font library, he or she may construct the character by himself or herself and add the required Chinese character into the font library, which makes it easy to use.

### The Second Embodiment

The present embodiment provides a Chinese character constructing method, comprising the following steps:

S01, obtaining Chinese character components through a Chinese character component obtaining unit; in other words, obtaining glyph data of various Chinese character components so as to provide the basis for constructing characters using the Chinese character components.

Preferably, the Chinese character component obtaining unit is at least one of a handwriting recording device, an image obtaining device, an image processing device, and a data storage device. Apparently, the specific approach of obtaining the Chinese character component may differ depending on Chinese character component obtaining units; for example, when a handwriting recording device is used, glyph designers may directly handwrite the specific Chinese character component (or Chinese character), and the handwriting recording device obtains the data of the written Chinese character component; when an image obtaining device is used, glyph designers may write down the Chinese character component (or Chinese character) on paper, then obtain the data of the Chinese character component by scanning or photographing; when an image processing device is used, the image of the Chinese characters designed by glyph designers or the Chinese character in the existing font library may be “split” into different Chinese character components; and when a data storage device is used, the data of the previously stored Chinese character component may be imported directly.

S02, granting a component code to the obtained Chinese character component to build a Chinese character component library, such that the Chinese character component and the corresponding component code are stored in the Chinese character component library; in other words, making the Chinese character component correspond to the component code and building a database in a specific format.

During the process of granting the component code, one component code can generally be granted to multiple Chinese character components of the same (or similar) shape (e.g. multiple “ [symbol] ” components of the same shape). Such an approach is relatively adapted to be combined with the prior art, and the amount of codes is small, which makes it easy to grasp. However, it needs to make a further selection from the multiple Chinese character components of the same shape in the subsequent steps; of course, it is also feasible to grant an individual component code to each Chinese character component.

Apparently, since the amount of Chinese character components is much less than the amount of Chinese characters, the operation of obtaining a Chinese character component of a certain font (or building a Chinese character component library) is apparently much easier than the operation of constructing all the Chinese characters of such font; meanwhile, since a Chinese character is composed of various Chinese character components, after the Chinese character component library is built, the Chinese character components therein can be automatically combined so as to obtain a large amount of Chinese characters of said font, thereby the efficiency of constructing Chinese characters is increased greatly and the cost is reduced.

S03, obtaining component parameters of the Chinese character component in the Chinese character component library, and storing the component parameters in the Chinese character component library and selecting the Chinese character components of the same shape according to the component parameters. Obtaining the component parameters may provide convenience for the subsequent steps, for example, when it is required to select one Chinese character component from multiple Chinese character components of the same shape corresponding to one component code for constructing a character, the selection can be made according to their component parameters. Wherein, the component parameters can be obtained by calculating the data of the Chinese character components in the Chinese character components library, but since the calculating process may be a conventional approach of analyzing and processing images, its detailed descriptions will be omitted here. Of course, the component parameters may also be calculated or obtained (such as inputted) at the time of obtaining the Chinese character components.

Preferably, the component parameters comprise at least one of height of the component, width of the component, aspect ratio of the component, area of the component, black-white ratio of the component, center of gravity of the component, source character of the component, original position of the component, recommended position of the component. Wherein the height of the component, the width of the component, the aspect ratio of the component, and the area of the component are easy to understand, which will not be explained specifically. The black-white ratio of the component refers to the ratio of area between the black portion (or the portion occupied by strokes) and the remaining blank portion in the graphics of the Chinese character component, which reflects whether the Chinese character component is very “fully” occupied by strokes. The center of gravity of the component indicates the position of the center of gravity of the whole Chinese character component if the strokes of the Chinese character component are regarded as entities with uniform weight. The source character of the component and the original position of the component indicate from which part of which Chinese character the Chinese character component is extracted, and the recommended position of the component indicates the Chinese character component is preferably used at which position (such as upper, left) of a Chinese character in what structure (such as left-right structure, half-enclosed structure). All of the three parameters can facilitate selecting the most appropriate Chinese character components for constructing the character (for example, it is apparent that the Chinese component from the upper portion of a Chinese character in an up-down structure is most possibly suitable for use in the upper portion of other Chinese characters in the up-down structure).

S04, obtaining a character code, a component code, and a structure code of a Chinese character to be constructed, and extracting corresponding Chinese character components from the Chinese character component library according to the component code; that is, determining what Chinese character is to be constructed, which Chinese character components this Chinese character is composed of, and where the respective components are located by obtaining the character code, the component code, and the structure code.

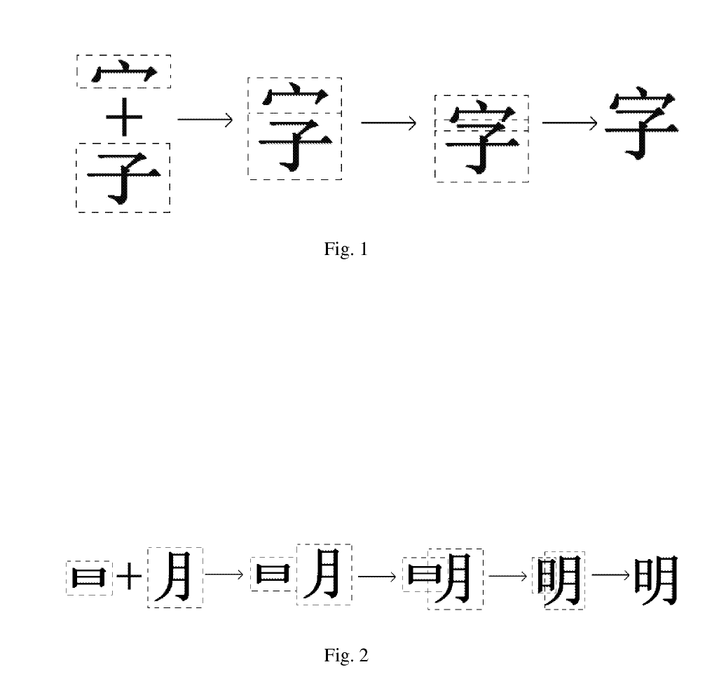

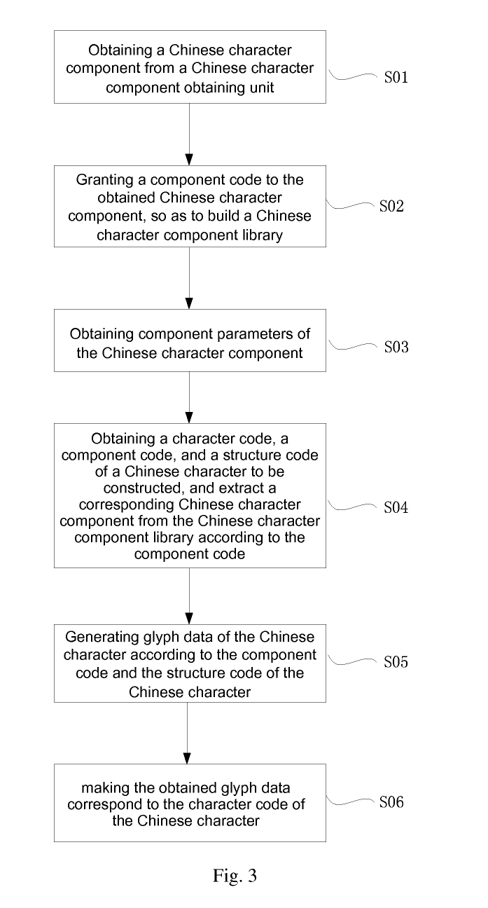

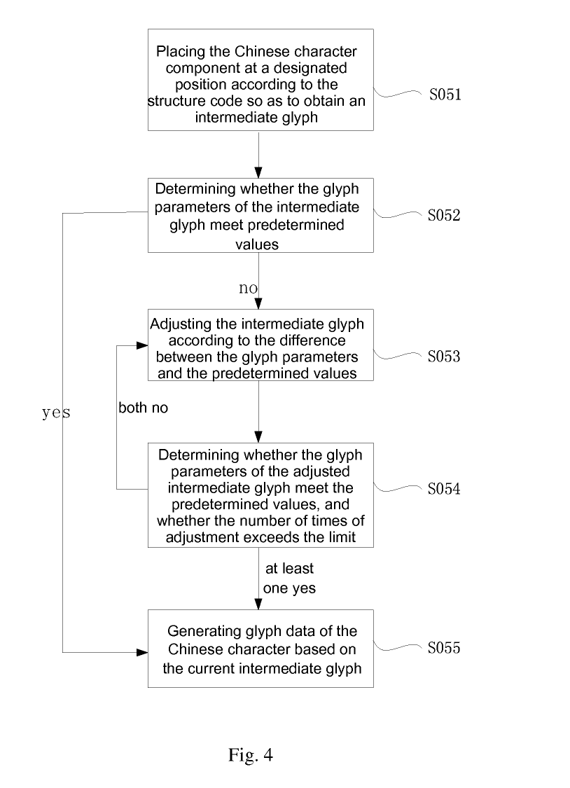

For example, in FIG. 1, the upper component “ [symbol] ” and the lower component “ [symbol] ” are selected to construct the character “ [symbol] ”; and in FIG. 2, the left component “ [symbol] ” and the right component “ [symbol] ” are selected to construct the character “ [symbol] ”.

The character code may be a conventional Chinese character code such as Unicode, GB2312, GB18030, GB13000 (i.e., GBK), Big5 and the like, and it is used to represent the Chinese character to be constructed.

The structure code specifies the structure of the Chinese character and the positions of respective Chinese character components in the Chinese character. Preferably, the structure code can be a structure code of IDS attributes in ISO 10646 Standard, wherein said IDS attribute is a code for Chinese character structure attributes, and different codes indicate that the Chinese characters are in different structures (such as left-right structure, up-down structure, left-middle-right structure, half-enclosed structure and the like). Apparently, since one Chinese character might be formed by multiple Chinese character components (i.e. having multiple component codes), the positions of the Chinese character components can be determined through certain rules, for example, when the structure code indicates that the Chinese character is in left-right structure, it can be specified that the earlier input component code represents the left Chinese character component, and the later input component code represents the right Chinese character component.

Preferably, in the Chinese character component library, one component code generally corresponds to a plurality of Chinese character components of the same shape, then in step S04, extracting a corresponding Chinese character component from the Chinese character component library according to the component code specifically comprises: obtaining a plurality of Chinese character components of the same shape that correspond to the component code according to the component code, then extracting the desired Chinese character component from the plurality of Chinese character components of the same shape according to the component parameters.

Apparently, when one component code represents a plurality of Chinese character components of the same shape, if it is required to extract a corresponding Chinese character component from the Chinese character component library, the user may be allowed to further select which Chinese character component is to be used specifically; for instance, after the user inputs the component code of the component “ [symbol] ”, the system can provide images of a plurality of components “ [symbol] ” of the same shape but in different forms and the corresponding component parameter information for the user to select, and after the user selects a certain component “ [symbol] ”, the system extracts a corresponding Chinese character component from the Chinese character component library.

Preferably, the character code, the component code, and the structure code are obtained through an input device. Apparently, the specific approaches of inputting the character code, the component code, and the structure code are various; for example, they can be input via a keyboard, or via a speech recognition device or a handwriting recognition device etc.; one can input the character code first and then input the corresponding component code and structure code, or one can also input the component code and the structure code first and then input the character code; the input contents can be direct codes, or characters or symbols which will be automatically converted into codes by the system after being input, for example, when one intends to input the Chinese character “ [symbol] ”, he or she may either directly input its Unicode character code “21834”, or input the Chinese character “ [symbol] ” by using Pinyin input method and the like; as another example, when one intends to input the component code of the component “ [symbol] ”, he or she may directly input its code or input the Chinese characters of “Bao Gaitou ( [symbol] )” which will be automatically converted into the corresponding component code by the system.

The method of the present embodiment is particularly applicable when the user constructs characters by himself or herself. When the user wants to use a character that is not contained in the font library, he or she can use the method of the present embodiment to construct the character and add it into the font library. Of course, when an entire font library is to be built, the character constructing method of the present embodiment can also be used, or different Chinese characters (or character codes) can be provided by the system one by one, and then the corresponding component codes and structure codes are selected manually.

S05, generating glyph data of the Chinese character by using the Chinese character component according to the structure code; that is to say, placing the selected Chinese character component at a specific position according to the structure code to form the desired glyph data of the Chinese character.

Preferably, this step further comprises a process of optimizing the glyph data using loop computation, the specific method may comprise:

S051, placing the Chinese character component at a designated position according to the structure code so as to obtain an intermediate glyph;

For example, the component “ [symbol] ” is placed at the upside and the component “ [symbol] ” is placed at the underside, then the two components are combined to form the third character “ [symbol] ” from the right side in FIG. 1; or, the component “ [symbol] ” is placed at the left side and the component “ [symbol] ” is placed at the right side, then the two components are combined to form the fourth character “ [symbol] ” from the right side in FIG. 2.

S052, determining whether the glyph parameters of the intermediate glyph meet predetermined values, and if yes, proceeding to step S055, otherwise proceeding to step S053; wherein the glyph parameters of the intermediate glyph can be obtained by analyzing and calculating the intermediate glyph or by calculating the component parameters of the Chinese character component in the Chinese character component library. This step aims to judge the current intermediate glyph (such as whether it is beautiful or not, whether it complies with people's reading habit) so as to determine whether it should be adjusted.

Apparently, the structures of Chinese characters which are deemed “beautiful” generally has certain common characteristics, for example, the height, width, and area of the whole character are within a certain scope, the aspect ratio is approximately 1, the center of gravity of the whole Chinese character is close to the geometric center of the Chinese character, the distance between the respective Chinese character components is relatively small, the size scale thereof is appropriate and the distribution thereof is even; moreover, these common characteristics can usually be reflected through certain parameters. Therefore, some predetermined values of the glyph parameters can be set, and the glyph can be judged by determining whether the glyph parameters of the intermediate glyph meet these predetermined values.

Of course, the selection of the predetermined values and the specific values may differ depending on Chinese character structures (for instance, the parameter of distance between components is not necessary for an independently structured character, and the predetermined values of the parameter of distance between components of characters in up-down structure and up-middle-down structure are definitely not the same).

Meanwhile, there are also various methods for determining whether the glyph parameters meet the predetermined values, for instance, one can determine whether a plurality of glyph parameters meet the corresponding predetermined values respectively, or whether the comprehensive value obtained by calculating a plurality of glyph parameters meets a predetermined value, or a certain (or some) glyph parameter(s) can be judged first, and only when the glyph parameter(s) is (are) eligible (or ineligible), other glyph parameters are judged.

Preferably, the glyph parameter comprises at least one of height of the Chinese character, width of the Chinese character, aspect ratio of the Chinese character, area of the Chinese character, black-white ratio of the Chinese character, center of gravity of the Chinese character, height of the component, width of the component, aspect ratio of the component, area of the component, black-white ratio of the component, center of gravity of the component, distance between components, size ratio between components. Parameters such as the width of the Chinese character and the height of the Chinese character refer to the corresponding parameters of the whole intermediate glyph, and parameters such as the area of the component and the black-white ratio of the component refer to the corresponding parameters of respective Chinese character components in the intermediate glyph; the distance between components refers to the distance between respective Chinese character components in the intermediate glyph (it may be the distance between the rims of the Chinese character components, or the distance between the centers of the Chinese character components), and can reflect whether the positions of respective Chinese character components are appropriate or not; the size between components refers to the proportions of the sizes of respective Chinese character components (it may be area ratio, height ratio etc.), and can reflect whether the sizes of respective Chinese character components in the Chinese character are appropriate or not.

For example, The upper and lower parts of the third character “ [symbol] ” (i.e., the middle glyph) from the right side in FIG. 1 obtained in step S051 look like being separated from each other, and after calculation, it would be found that the distance between components (the distance between the upper and lower parts) is lightly large, thus it is determined that the glyph parameter of this intermediate glyph does not meet the predetermined value; similarly, the distance between components (the distance between the left and the right parts) of the fourth character “ [symbol] ” (i.e., the middle glyph) from the right side in FIG. 2 obtained in step S051 is also slightly large, so it is determined that the glyph parameter of this intermediate glyph does not meet the predetermined value.

S053, adjusting the intermediate glyph according to the difference between the glyph parameter and the predetermined value; i.e., determining specifically which part of the intermediate glyph is not appropriate based on the result of determination in step S052, and making corresponding adjustment so as to obtain a new intermediate glyph.

Apparently, the adjustment in this step should be made according to the difference between the glyph parameter of the intermediate glyph and the predetermined value; for instance, if it is found that the height of the Chinese character is slightly large, the adjustment operation that can reduce the height of the Chinese character should be performed until it is consistent or close to the predetermined value thereof.

Preferably, the operation of adjusting the intermediate glyph comprises at least one of adjusting the height of the Chinese character, adjusting the width of the Chinese character, adjusting the area of the Chinese character, adjusting the black-white ratio of the Chinese character, adjusting the height of the component, adjusting the width of the component, adjusting the area of the component, adjusting the black-white ratio of the component, adjusting the position of the component. Adjusting the height of the Chinese character and adjusting the width of the Chinese character and the like refer to adjusting the Chinese character as a whole, and adjusting the height of the component and adjusting the position of the component and the like refer to adjusting respective Chinese character components in the Chinese character separately; adjusting the black-white ratio of the Chinese character and adjusting the black-white ratio of the component refer to changing the “thickness” of the strokes in the glyph, so as to change the proportions occupied by the strokes; adjusting the area of the Chinese character and adjusting the area of the component refer to zooming in and zooming out the Chinese character component or the Chinese character under the condition that the aspect ratio is not changed; and adjusting the position of the component refers to moving the Chinese character component in the intermediate glyph. Of course, there are also many other operations of adjusting the intermediate glyph (e.g., inclining or twisting the Chinese character or the Chinese character component), which will not be explained here one by one.

Apparently, the adjusting operations are not in one-to-one correspondence with the glyph parameters. One glyph parameter may be obtained by several different adjusting operations, and one adjusting operation may also be used for changing several glyph parameters. For example, if the parameter of center of gravity of the Chinese character of the intermediate glyph is ineligible, it can be solved either by the operation of adjusting the position of the component, by the operation of adjusting the area of the component, or by the operations of adjusting the height of the component, adjusting the width of the component, adjusting the height of the Chinese character, adjusting the width of the Chinese character and the like; similarly, the operation of adjusting the position of the component can be used not only for adjusting the center of gravity of the Chinese character, but also for adjusting the distance between components, and also for adjusting the height of the Chinese character and the width of the Chinese character.

For example, it is determined in step S052 that the distance between components (the distance between the upper and the lower parts) of the third character “ [symbol] ” from the right side in FIG. 1 is slightly large, thus the operation of adjusting the position of the component is performed, so that the upper and the lower Chinese character components are “drawn closer” to each other to obtain the second character “ [symbol] ” from the right side; and it is determined in step S052 that the distance between components (the distance between the left and the right parts) of the fourth character “ [symbol] ” from the right side in FIG. 2 is slightly large, thus the operation of adjusting the position of the component is performed so that the left and the right Chinese character components are “drawn closer” to each other to obtain the third character “ [symbol] ” from the right side. Apparently, although only one adjusting operation is performed in this step in the examples of FIG. 1 and FIG. 2, it is also feasible to perform multiple adjusting operations in this step.

S054, determining whether the adjusted glyph parameters of the intermediate glyph meet the predetermined values, and whether the number of times of adjustments exceed the limit, if at least one yes, proceeding to step S055, otherwise, returning to step S503. That is to say, the adjusted glyph parameters of the intermediate glyph are judged again, and if they are still ineligible, the process continues to repeat the adjustment until the glyph parameters are eligible or the number of times of adjustment exceeds the limit.

For example, all the glyph parameters of the second character “ [symbol] ” from the right side in FIG. 1 are eligible after being adjusted once, so it directly proceeds to step S055; on the other hand, although the distance between components of the third character “ [symbol] ” from the right side in FIG. 2 is eligible after being adjusted once, the component “ [symbol] ” at its left side is apparently too wide and too short, i.e., the aspect ratio of its components is still ineligible, so it should return to step S053 to perform the operations of adjusting the height the width of the component “ [symbol] ”, so as to obtain the second character “ [symbol] ” from the right side, and all the glyph parameters of this character “ [symbol] ” are eligible, so it can proceed to steep S055. Of course, as stated above, if it has been directly determined in step S052 that the distance between components and component aspect ratio of the fourth character “ [symbol] ” from the right side in FIG. 2 are both ineligible, and the operations of adjusting the distance between components, adjusting the height of the component and adjusting the width of the component have been performed at the same time in step S053, the second character “ [symbol] ” from the right side in FIG. 2 would be obtained after one step, and it would be unnecessary to repeat the adjustments; thus it can be seen that the specific process of judging the glyph parameters and adjusting the intermediate glyph may be various.

Apparently, the above adjustments are not the same as manual operations after all. It might be difficult to make reasonable adjustments to some glyph parameters, or other glyph parameters might become ineligible while one glyph parameter is adjusted to be eligible, hence, such adjustments might take a very long period of time (i.e., performing many times of loop), even might fall into an endless loop without stopping; in order to avoid such an phenomenon, the number of times of adjustment can be recorded (e.g., the number of times of adjustment increases by one every time an adjustment is made, or the remaining number of times of adjustment decreases by one every time an adjustment is made), and it should be determined whether the number of times of adjustment exceeds the limit (e.g. the adjustment is performed too many times), if yes, it would be forced to proceed to step S055 to terminate the adjustment no matter the glyph parameters are ineligible or not.

S055, generating the glyph data of the Chinese character based on the current intermediate glyph; that is, generating glyph data in forms of a bitmap, a vectogram, a skeleton map used in the font library.

For example, the rightmost character “ [symbol] ” in FIG. 1 and the rightmost character “ [symbol] ” in FIG. 2 are taken as the final glyph data.

S06, making the obtained glyph data correspond to the character code of the Chinese character; i.e., determining explicitly which Chinese character the glyph data represent, so as to complete the character construction.

### The third Embodiment

The present embodiment provides a Chinese character constructing method, which is similar to the Chinese character constructing method of the second embodiment, and the difference lies in:

In step S04, rather than being input by the user, the character code, the component code, and the structure code of the Chinese character to be constructed are obtained from a pre-stored code correspondence table; the code correspondence table stores the correspondence of the character code, the component code, and the structure code of the Chinese character to be constructed.

That is to say, a code correspondence table can be constructed in advance (it can either be constructed dedicatedly or be generated simultaneously during the preceding constructing process), thus when constructing characters later, the system can read the character code and the corresponding component code and the structure code one by one from the code correspondence table and accomplish the constructing process automatically. In this way, after a font library (especially a super font library) is built, a code correspondence table for the font library can be obtained simultaneously, thereby, the code correspondence table can be used to accomplish the character constructing work of many other font libraries full-automatically (of course, it requires consistency of the code rules of the Chinese character component libraries used in respective character constructing processes), thus the character constructing efficiency is further improved greatly.

### The Fourth Embodiment

The present embodiment provides a font library building method, comprising the steps of: generating glyph data and the character code of the corresponding Chinese character by using the Chinese character constructing method of the above-described embodiments; i.e., constructing Chinese characters required in the font library using above-described Chinese character constructing method. If the method of the third embodiment is used, this step can be performed full-automatically, and if the method of the second embodiment is used, the system may give different Chinese characters or character codes one by one (of course they can also be input by the user), then the user selects the corresponding component codes and structure codes; and

building a font library using the obtained glyph data; i.e., “loading the library” with the glyph data according to the format required by the font library to obtain available font library files.

In the font library building method of the present embodiment, a Chinese character component library can be used to accomplish the character constructing process automatically so as to build a font library, thereby increasing the efficiency of building a font library greatly, reducing the time of building the font library, and reducing the cost of building the font library, and this is especially true for a super font library; meanwhile, when the user wants to use a rare character or a self-constructed character that is not contained in the font library, he or she may construct the character by himself or herself and add the required Chinese character into the font library, which makes it easy to use.

### The fifth Embodiment

The present embodiment provides a Chinese character constructing device, comprising: a code obtaining unit for obtaining a character code, a component code, and a structure code of a Chinese character to be constructed, wherein the structure code specifies a structure of the Chinese character and a position of the Chinese character component in the Chinese character;

a Chinese character component extracting unit for extracting a corresponding Chinese character component from a Chinese character component library according to the component code; and

a glyph data generating unit for generating glyph data of the Chinese character by using the Chinese character component according to the structure code, and making the glyph data of the Chinese character correspond to the character code of the Chinese character.

Preferably, the Chinese character constructing device further comprises a Chinese character component library storing unit for storing the Chinese character component library in which the Chinese character component and the corresponding component code are stored.

Preferably, the Chinese character constructing device further comprises a Chinese character component obtaining unit for obtaining a Chinese character component and providing it to the Chinese character component library storing unit; and the Chinese character component obtaining unit is at least one of a handwriting recording device, an image obtaining device, an image processing device, and a data storage device.

Preferably, the Chinese character component library also stores component parameters of the Chinese character components, the component parameters comprise at least one of height of the component, width of the component, aspect ratio of the component, area of the component, black-white ratio of the component, center of gravity of the component, source character of the component, original position of the component, recommended position of the component.

The Chinese character component extracting unit is further used for extracting the component parameters in the Chinese character component library, and selecting a desired Chinese character component from the extracted plurality of Chinese character components of the same shape that correspond to the same component code according to the component parameters.

Of course, the Chinese character constructing device may further comprise functional units, such as a unit for calculating component parameters, a unit for calculating glyph parameters, a unit for adjusting the intermediate glyph, that correspond to the processes of the Chinese character constructing methods of the above respective embodiments; the respective units of the Chinese character constructing device can be either independent, or integrated as a whole, for example, they can be integrated as a processor and a memory.

The character constructing process can be accomplished automatically by using the Chinese character constructing device of the present embodiment, thereby increasing the character constructing efficiency greatly, reducing the character constructing time and reducing the character constructing cost; meanwhile, when the user wants to use a rare character or a self-constructed character that is not contained in the font library, he or she may construct the character by himself or herself and add the required Chinese character into the font library, which makes it easy to use.

### The Sixth Embodiment

The present embodiment provides a character constructing method, comprising:

obtaining a character code, a component code, and a structure code of a character to be constructed, and extracting a corresponding character component from a component library according to the component code, wherein the structure code specifies a structure of the character and a position of the character component in the character; and

generating glyph data of the character by using the character component according to the structure code, and making the glyph data of the character correspond to the character code of the character.

The character to be constructed in the present embodiment refers to a character comprising at least one component and having a certain structure, for example, Chinese character, Korean character, Japanese character etc., which can be constructed by above-mentioned method. It shall be explained that the detailed implementing process of the character constructing method of the present embodiment is similar to the Chinese character constructing method of the first to third embodiments, which will not be elaborated here.

### The Seventh Embodiment

The present embodiment provides a font library building method, comprising:

generating glyph data and a character code corresponding to a character by using the character constructing method of the sixth embodiment; and

building a font library by using the obtained glyph data of the character.

### The Eighth Embodiment

The present embodiment provides a character constructing device, comprising:

a code obtaining unit for obtaining a character code, a component code, and a structure code of a character to be constructed, wherein the structure code specifies a structure of the character and a position of the character component in the character;

a component extracting unit for extracting a corresponding character components from a component library according to the component code; and

a glyph data generating unit for generating glyph data of the character by using the character component according to the structure code, and making the glyph data of the character correspond to the character code of the character.

The character to be constructed in the present embodiment refers to a character comprising at least one component and having a certain structure, for example, Chinese character, Korean character, Japanese character etc., which can be constructed by said device. It shall be explained that the specific units of the character constructing device of the present embodiment is similar to those of the Chinese character constructing device of the fifth embodiment, which will not be elaborated here.

It could be understood that the above embodiments are only illustrative embodiments for explaining the principles of the present invention, however, the present invention is not limited thereto. For an ordinary skilled person in the art, various modifications and improvements can be made without departing from the spirit and essence of the present invention, and such modifications and improvements should also be deemed within the scope of the present invention.

1. A character constructing method, comprising the steps of:
obtaining a character code, a component code, and a structure code of a character to be constructed, and extracting a corresponding character component from a character component library according to the component code, wherein the structure code specifies a structure of the character and a position of the character component in the character; and
generating glyph data of the character by using the character component according to the structure code, and making the glyph data of the character correspond to the character code of the character.

2. The character constructing method according to claim 21, further comprising, before obtaining a character code, a component code, and a structure code of a Chinese character to be constructed, the step of:
obtaining a Chinese character component, and granting a component code to the Chinese character component to build a Chinese character component library, so that the Chinese character component and the corresponding component code are stored in the Chinese character component library.

3. The character constructing method according to claim 21, wherein the step of obtaining a Chinese character component is specifically obtaining a Chinese character component through a Chinese character component obtaining unit, the Chinese character component obtaining unit being at least one of a handwriting recording device, an image obtaining device, an image processing device, and a data storage device.

4. The character constructing method according to claim 21, wherein the step of constructing a Chinese character component library further comprises:
obtaining component parameters of the Chinese character component in the Chinese character component library, and storing the component parameters in the Chinese character component library, the component parameters comprising at least one of height of the component, width of the component, aspect ratio of the component, area of the component, black-white ratio of the component, center of gravity of the component, source character of the component, original position of the component, and recommended position of the component; and selecting Chinese character components of the same shape according to the component parameters.

5. The character constructing method according to claim 4, wherein in the Chinese character component library, one component code corresponds to a plurality of Chinese character components of the same shape, and the step of extracting a corresponding Chinese character component from a Chinese character component library according to the component code specifically comprises: obtaining a plurality of Chinese character components of the same shape that correspond to the component code according to the component code, then extracting a desired Chinese character component from the plurality of Chinese character components of the same shape according to the component parameters.

6. The character constructing method according to claim 21, wherein the structure code is a structure code of IDS attributes in ISO 10646 Standard.

7. The character constructing method according to claim 21, wherein the step of obtaining a character code, a component code, and a structure code of a Chinese character to be constructed comprises:
obtaining a character code, a component code, and a structure code of a Chinese character to be constructed through an input device;
obtaining a character code, a component code, and a structure code of a Chinese character to be constructed from a pre-stored code correspondence table, in which the correspondence of the character code, the component code, and the structure code of a Chinese character to be constructed is stored.

8. The character constructing method according to claim 7, wherein the step of generating glyph data of the Chinese character by using the Chinese character component according to the structure code comprises:
Step 1 of placing the Chinese character component at a designated position according to the structure code so as to obtain an intermediate glyph;
Step 2 of determining whether the glyph parameters of the intermediate glyph meet predetermined values, if yes, proceeding to step 5, otherwise, proceeding to step 3;
Step 3 of adjusting the intermediate glyph based on the difference between the glyph parameters and the predetermined values;
Step 4 of determining whether the glyph parameters of the adjusted intermediate glyph meet the predetermined values, and whether the number of times of adjustment exceeds a limit, and if at least one yes, proceeding to step 5, otherwise, returning to step 3;
Step 5 of generating glyph data of the Chinese character according to the current intermediate glyph.

9. The character constructing method according to claim 8, wherein the glyph parameter comprises at least one of height of the Chinese character, width of the Chinese character, aspect ratio of the Chinese character, area of the Chinese character, black-white ratio of the Chinese character, center of gravity of the Chinese character, height of the component, width of the component, aspect ratio of the component, area of the component, black-white ratio of the component, center of gravity of the component, distance between components, and size ratio between components.

10. The character constructing method according to claim 8, wherein adjusting the intermediate glyph in step 3 comprises at least one of the following adjusting operations:
adjusting the height of the Chinese character, adjusting the width of the Chinese character, adjusting the area of the Chinese character, adjusting the black-white ratio of the Chinese character, adjusting the height of the component, adjusting the width of the component, adjusting the area of the component, adjusting the black-white ratio of the component, adjusting the position of the component.

11. The character constructing method according to claim 8, wherein the glyph parameters of the intermediate glyph are obtained by analyzing and calculating the intermediate glyph, or by calculating the component parameters of the Chinese character component in the Chinese character component library.

12. A font library building method, comprising:
generating glyph data and a character code corresponding to a character by using the character constructing method according to claim 11; and
building a font library by using the obtained glyph data of the Chinese character.

13. A character constructing device, comprising:
a code obtaining unit for obtaining a character code, a component code, and a structure code of a character to be constructed, wherein the structure code specifies a structure of the character and a position of the character component in the character;
a character component extracting unit for extracting a corresponding character component from a character component library according to the component code; and
a glyph data generating unit for generating glyph data of the character by using the character component according to the structure code, and making the glyph data of the character correspond to the character code of the character.

14. The character constructing device according to claim 23, further comprising:
a Chinese character component library storing unit for storing the Chinese character component library in which the Chinese character component and the corresponding component code are stored.

15. The character constructing device according to claim 14, further comprising:
a Chinese character component obtaining unit for obtaining a Chinese character component and providing it to the Chinese character component library storing unit.

16. The character constructing device according to claim 15, wherein the Chinese character component obtaining unit is at least one of a handwriting recording device, an image obtaining device, an image processing device, and a data storage device.

17. The character constructing device according to claim 14, wherein the Chinese character component library also stores component parameters of the Chinese character components, and the component parameters comprise at least one of height of the component, width of the component, aspect ratio of the component, area of the component, black-white ratio of the component, center of gravity of the component, source character of the component, original position of the component, and recommended position of the component; and
the Chinese character component extracting unit is further used for extracting the component parameters in the Chinese character component library, and selecting a desired Chinese character component from the extracted plurality of Chinese character components of the same shape that correspond to the same component code according to the component parameters.

18. (canceled)

19. (canceled)

20. (canceled)

21. The character construction method according to claim 1, wherein the character is a Chinese character.

22. The font library building method according to claim 12, wherein the character is a Chinese character.

23. The character constructing device according to claim 13, wherein the character is a Chinese character.
